(19) United States
(12) Patent Application Publication
(10) Pub. No.: US 2026/0310723 A1
(43) Pub. Date: Oct. 8, 2026

(54) AUDIO SYNCHRONIZATION THROUGH LARGE LANGUAGE MODELS AND DIFFERENTIAL EQUATION-BASED MEL SPECTOGRAM INVERSION

(71) Applicant: Disney Enterprises, Inc., Burbank, CA (US)

(72) Inventors: Dan Sebastian RUTA, Zürich (CH); Logan MOLNAR, Los Angeles, CA (US); Oscar GARCIA, Chino, CA (US); Muhammad JAVED, Zurich (CH); Guglielmo CAMPORESE, Zurich (CH); Shinobu HATTORI, Los Angeles, CA (US)

(21) Appl. No.: 19/169,314

(22) Filed: Apr. 3, 2025

(51) Int. Cl. G06F 16/783; G06F 40/58; G10L 13/08; G10L 15/26

(52) U.S. Cl. CPC G06F 16/7844; G06F 16/7834; G06F 40/58; G10L 13/08; G10L 15/26

(57) ABSTRACT

Embodiments provide techniques for audio synchronization with improved timing alignment. The audio extracted from a video file is transcribed to generate an original script. Pause and timing information is extracted from the audio, where the pause and timing information comprises at least one of pauses, natural gaps, or a duration of a speech segment in the audio. A new script is generated from the original script using a language model, where the new script is structured to align with the pause and timing information of the audio. The synthesized audio is generated using the new script with a text-to-speech model.

### BACKGROUND

When changing the audio content of a video, efforts often focus on achieving lip synchronization, which involves adjusting the visible lip movements of the speaker to match the audio content. While these approaches address visual alignment, they neglect audio synchronization. Audio synchronization typically involves adjusting the timing, pauses, and flow of the new content audio to match the original video's structure and rhythm. Without proper audio synchronization, the new content may overrun or finish too early relative to the speaker's visible lip movements or result in unnatural-sounding speech that lacks proper cadence and natural breaks. These problems can undermine the overall quality of the final video product, giving users a disjointed experience where the audio and visible lip movements are poorly synchronized.

### SUMMARY

One embodiment presented in this disclosure provides a method, including transcribing audio extracted from a video file to generate an original script, extracting pause and timing information from the audio, where the pause and timing information comprises at least one of pauses, natural gaps, or a duration of a speech segment in the audio, generating a new script from the original script using a language model, where the new script is structured to align with the pause and timing information of the audio, and generating synthesized audio using the new script with a text-to-speech model.

Other embodiments in this disclosure provide computer-readable media containing computer program code that, when executed by one or more computer processors, performs operations in accordance with one or more of the above methods, as well as systems comprising one or more memories collectively containing one or more programs, and one or more processors, where the one or more processors are configured to, individually or collectively, perform operations in accordance with one or more of the above methods.

### BRIEF DESCRIPTION OF THE DRAWINGS

So that the manner in which the above recited aspects are attained and can be understood in detail, a more particular description of embodiments described herein, briefly summarized above, may be had by reference to the appended drawings.

It is to be noted, however, that the appended drawings illustrate typical embodiments and are therefore not to be considered limiting; other equally effective embodiments are contemplated.

FIG. 1 depicts an example of an original script in English and a corresponding example of a translated script in another language, both provided with word-level timestamps, according to some embodiments of the present disclosure.

FIG. 2 is an example of an original script and a corresponding example of a rephrased script with new content, both provided with word-level timestamps, according to some embodiments of the present disclosure.

FIG. 3 depicts an example workflow for converting translated or rephrased scripts into audio, comparing and aligning mel spectrograms, and integrating refined audio into final video output, according to some embodiments of the present disclosure.

FIG. 4 depicts an example method for generating synthesized audio from a translated or rephrased script based on original audio timing and pauses, according to some embodiments of the present disclosure.

FIG. 5 depicts an example method for refining synthesized audio using ODE-based mel spectrogram inversion and integrating synthesized audio with video content, according to some embodiments of the present disclosure.

FIG. 6 is a flow diagram depicting an example method for audio synchronization, according to some embodiments of the present disclosure.

FIG. 7 depicts an example computing device configured to perform various aspects of the present disclosure, according to some embodiments of the present disclosure.

### DETAILED DESCRIPTION

When changing the speech content of a video, a common focus has been on achieving lip synchronization by adjusting the visible lip movements of the speaker to match the new audio content. This often requires computationally intensive video editing techniques, such as manipulating pixel-level details or using machine learning models to visually align the lips with the audio. While lip synchronization addresses visual alignment, audio synchronization is equally important. Audio synchronization ensures that the new audio script matches the original timing, pauses, and structure. Without addressing this, global timing issues can arise, such as audio overrunning or finishing too early relative to the speaker's visible lip movements. Furthermore, ignoring natural breaks or pauses in the audio can result in robotic or unnatural-sounding speech that fails to match the flow and cadence of the original content.

Embodiments of the present disclosure introduce methods, systems, and apparatuses for audio synchronization. The disclosed approaches involves analyzing the original audio to detect pauses and word-level timestamps, generating a translated or rephrased script using a large language model (LLM) where the script aligns with the detected timing and pauses, and converting the translated or rephrased script into synthesized audio using text-to-speech (TTS) system. The process further includes generating mel spectrograms for the original audio. The generated mel spectrogram is then used as a reference input for the ODE-based inversion process within the TTS system. The TTS system uses the original mel spectrogram to learn the intensity (or amplitude), timing, and frequency characteristics of the original audio. The TTS system then synthesizes the new audio by aligning the translated or rephrased script with the detected timing, pauses, and frequency variations of the original audio. Through the iterative refinement, the synthesized audio maintains the timing, pauses, and flow that closely resemble the original while accurately reflecting the content of the new script. Finally, the synthesized audio is integrated with the video, replacing the original audio track. If needed, lip synchronization adjustments or subtle visual modification may be applied to improve alignment in the final output.

At least some of the disclosed embodiments can improve the timing and structural alignment of newly generated speech content and enable seamless synchronization between the audio and the lip movements in the video. The generated video with new audio content provides a more cohesive and natural user experience, with audio that is authentic and visually aligned. These improvements make the disclosed embodiments highly valuable for a wide range of applications, including but not limited to, language translation or content adaptation and rephrasing for accessibility or creative purposes.

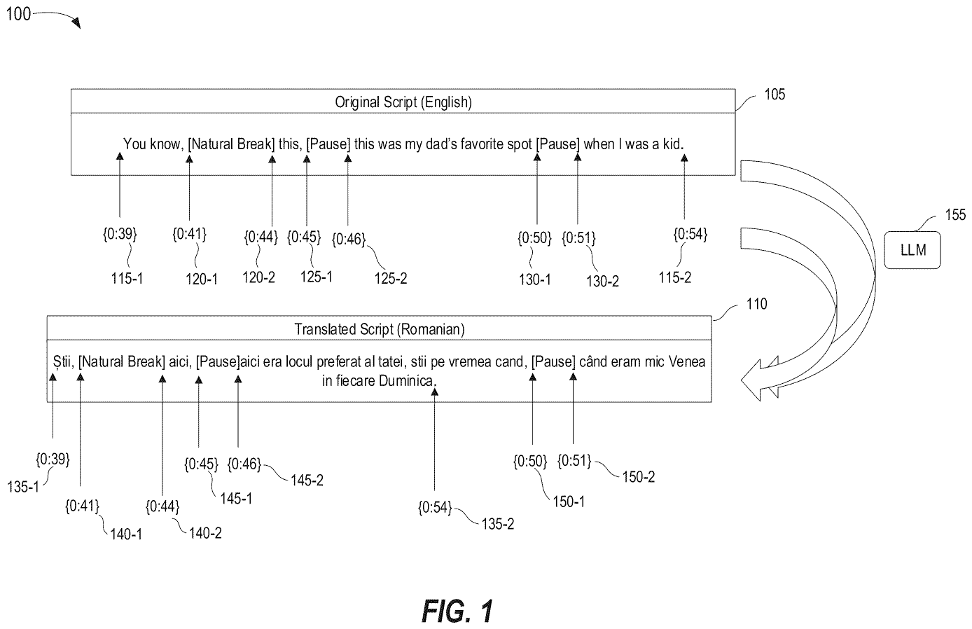

FIG. 1 depicts an example of an original script 105 in English and a corresponding example of a translated script 110 in another language, both provided with word-level timestamps, according to some embodiments of the present disclosure.

As depicted, the original script 105 is written in English, stating that “You know, this, this was my dad's favorite spot when I was a kid.” The script 105 includes a natural break after “you know,” and two pauses, one after “this” and one after “spot.” The breaks and pauses highlight the timing and rhythm of the spoken content. In some embodiments, the script 105 may be extracted from a video file. This may involve isolating the audio track from the video file, decoding the audio track to extract audio data, and converting the extracted data into a suitable format for further processing (e.g., MP3 or WAV). Speech-to-text techniques may then be applied to the audio data to detect and convert the spoken content into text.

The original script 105 is analyzed to identify timing and pause information. In some embodiments, transcription and analysis techniques (or tools) may be used to generate word-level timestamps, marking the start and end times of each word. This analysis may help to determine the duration (or length) of the speech within the audio, detect pauses or natural breaks, and identify their corresponding timestamps.

As depicted in FIG. 1, the sentence starts at 0:39 seconds with timestamp 115-1 and ends at 0:54 seconds with timestamp 115-2. The first natural break occurs after “you know,” starting at 0:41 seconds with timestamp 120-1 and ending at 0:44 with timestamp 120-2. The first pause is after “this,” starting at 0:45 seconds with timestamp 125-1 and ending at 0:46 seconds with timestamp 125-2. The second pause occurs after “spot,” starting at 0:50 seconds with timestamp 130-1 and ending at 0:51 seconds with timestamp 130-2. As used herein, a natural break refers to an interruption in speech that occurs naturally due to the rhythm of spoken language, such as between phrases or clauses (e.g., often indicated by commas or other punctuation). The natural breaks are used to improve the clarity and flow of communication. As used herein, a pause refers to an interruption in speech that is used for emphasis, to convey emotions, or to allow the listener to process information.

The analysis results, including the original script 105 and its associated timing and pausing information (e.g., starting and ending stamps 115, 120, 125, and 130), are then utilized by a large language model (LLM) 155 to generate a translated script 110 that aligns with the timing and structure of the original audio. In some embodiments, this process may begin with generating an initial translation of the original script in a target language (e.g., Romanian), which is often a literal translation of the original script. The LLM 155 may then refine the initial translation to ensure it matches the duration and flow of the speech segments in the original audio. Refinements may include inserting conjunctions, transitional phrases, or filter words into the translated script to align it with the detected pauses or natural breaks. In some embodiments, the translation may be rephrased to fit the exact duration (or length) of the speech within the original script.

As depicted, the original English script 105 is translated into Romanian as: “çtii, aici, aici era locul preferat al tatei, stii pe vremea cand, când eram mic Venea in fiecare Duminica.” The translated script 110 preserves the same overall length and aligns its natural breaks and pauses with the original one 105.

As depicted, the sentence starts at 0:39 seconds with timestamp 135-1 and ends at 0:54 seconds with timestamp 110-2. The starting and ending timestamps 135-1 and 135-2 correspond exactly to the original timestamps 115-1 and 115-2 for the English script 105. The first natural break follows “stii,” starting at 0:41 seconds with timestamp 140-1 and ending at 0:44 seconds with timestamp 140-2. The timestamps 140-1 and 140-2 are identical to these for the original natural break after “you know.” Similarly, the first pause after “aici” starts at 0:45 seconds (with timestamp 145-1) and ends at 0:46 seconds (with timestamp 145-2), and the second pause after “cand” starts at 0:50 seconds (with timestamp 150-1) and ends at 0:51 seconds (with timestamp 150-2), both matching the original timing precisely. The refinement of the literal translation to match the timing and pause data helps to maintain the natural flow, cadence, and structure of the original audio. When the translated script 110 is converted into audio and integrated with a video file, it better matches the speaker's lip movements and overall expressions and provides the audience with a more natural and cohesive viewing experience.

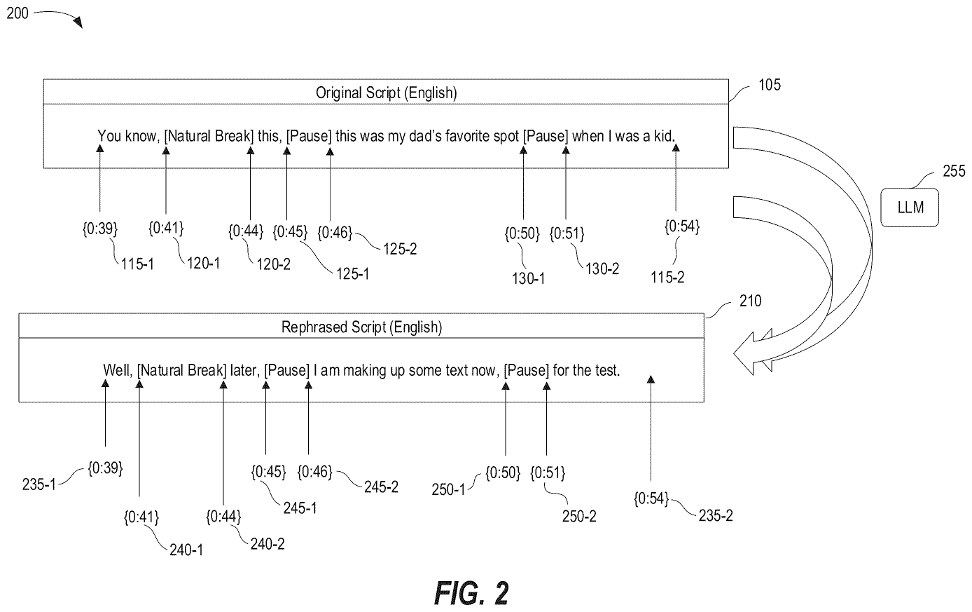

FIG. 2 is an example of an original script 105 and a corresponding example of a rephrased script with new content 210, both provided with word-level timestamps, according to some embodiments of the present disclosure.

In this figure, both the original script 105 and the rephrased script 210 are in English, with the same pauses, natural breaks, and overall length. The original script 105 is rephrased into new content as: “Well, later, I am making up some text now, for the test.” The rephrased script 210 introduces new content that differs from the original while preserving the overall timing and pause structure. The rephrased script may be initially generated based on content provided by users. To make the generated rephrase script match with the detected pauses (or breaks) and overall length of the original audio, the LLM 255 may adjust it by adding conjunctions, transitional phrases, or filler words. In some embodiments, the content of the rephrased script may be adjusted with new words to better match the length and timing of the original audio.

For example, the sentence within the rephrase script begins at 0:39 seconds for “well” with timestamp 235-1 and ends at 0:54 seconds for “test” with timestamp 235-2. The starting and ending timestamps 235-1 and 235-2 match exactly to the original timestamps 115-1 and 115-2. The first natural break occurs after “well,” starting at 0:41 seconds with timestamp 240-1 and ending at 0:44 with timestamp 240-2. The timestamps 240-1 and 240-2 are identical to these (e.g., 120-1 and 120-2) for the original natural break after “you know.” Additional, as illustrated, the first pause follows “later,” starting at 0:45 seconds with timestamp 245-1 and ending at 0:46 seconds with timestamp 245-2, and the second pause follows “now,” starting at 0:50 seconds with timestamp 250-1 and ending at 0:51 seconds with timestamp 250-2. Both pauses align precisely with the timing (e.g., 125-1, 125-2, 130-1, and 130-2) of the corresponding pauses in the original script 105.

In some embodiments, the rephrasing process using LLM 255 may be applied to various scenarios, such as replacing audio for creative purposes, updating education or marketing materials, or adapting content for regional location. By aligning the rephrased scripts with the original timing, the new audio may better match the speaker's lip movements when integrated with the original video. This alignment makes the overall video appear more natural and avoids a disjointed viewing experience. Additionally, the process described in FIGS. 1 and 2 provides a mechanism for audio synchronization by using re-wording and guidance from the speech envelope of the original audio. The disclosed approach is more cost-effective and requires less computational power compared to conventional methods that rely heavily on extensive visual editing or lip manipulation.

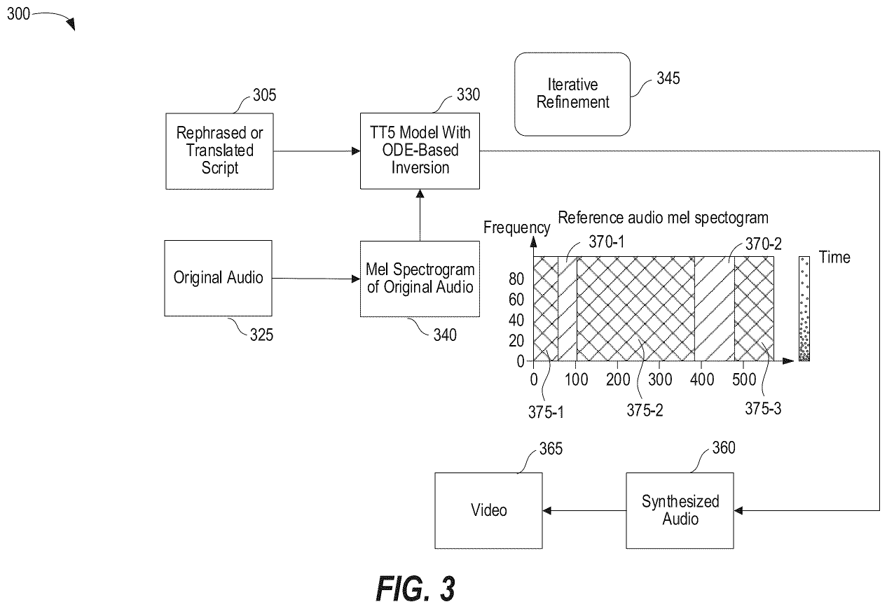

FIG. 3 depicts an example workflow 300 for converting translated or rephrased scripts into audio and integrating refined audio into final video output, according to some embodiments of the present disclosure.

As depicted, the rephrased or translated script 305 (which may correspond to the translated script 110 as depicted in FIG. 1, or the rephrased script 210 as depicted in FIG. 2) is processed along with the original audio 325, which corresponds to the original script (e.g., 105 of FIGS. 1 and 2). The original audio 325 is first converted into its corresponding mel spectrogram 340 using audio processing techniques. As used herein, a mel spectrogram is a representation of an audio signal's frequency content over time. As depicted, the reference audio mel spectrogram 350 provides an example of the appearance of such a time-frequency representation. The horizontal axis (x axis) represents time and shows how the sound evolves over time. The horizontal axis captures the temporal progression of the audio signal. The vertical axis (y axis) represents frequency, which is transformed from a liner frequency scale (e.g., Hertz) into the mel scale. The mel scale is a perceptual scale of pitches where equal distances correspond to equal perceived pitch difference. The mel scale can model how humans perceive sound frequencies better because it emphasizes lower frequencies (where human hearing is more sensitive) and compresses higher frequencies (where human sensitivity diminishes). In some embodiments, the color or brightness of the spectrogram represents amplitude (or intensity), indicating how loud each frequency is at a given moment. Darker areas 370-1 and 370-2, as depicted in the reference mel spectrogram, represent silent regions, while brighter areas 375-1 and 375-2 reflect higher-intensity (e.g., louder) sounds.

The mel spectrogram of the original audio 340 serves as a reference and is provided into the a text-to-speech (TTS) system 310 for ODE-based inversion. During this process, the mel spectrogram of the original audio 340 is used as the starting point, through which the TTS system 320 learns the intensity/amplitude, timing, and frequency characteristics of the original audio. The TTS system 320 uses this information, along with the rephrased or translated script 305, to generate new synthesized audio 360. In some embodiments, iterative refinement 345 may be performed during the generation of the synthesized audio 360 to ensure that the synthesized audio maintains similar timing, pauses, frequency distribution, and amplitude characteristics as the original audio. For example, if the reference mel spectrogram shows specific timing for pauses or variations in volume and intensity for certain phrases, these elements are refined in the synthesized audio to reduce difference. This process may be repeated iteratively until the differences between the synthesized audio 360 and the original audio 325 fall below a predefined threshold.

In some embodiments, the ODE-based inversion process may be performed iteratively over a predefined number of timesteps (e.g., 32 by default). In some embodiments, an inversion strength may be defined to determine how many steps are executed, with adjustments to start and end steps based on efficiency requirements. For example, with an inversion strength of 0.1, the system skips the first 10% of timesteps (e.g., steps 1-3) and performs 90% of the steps (e.g., starting from step 4 and running for 28 steps in total). The implementation of inversion strength saves computational resources while maintaining high-quality reconstruction of the audio waveform.

As depicted, once the synthesized audio 360 is generated, it is integrated into the original video file 365. The integration process may include deleting the original audio track 325 and replacing it with the newly generated synthesized audio 360. In some embodiments, additional adjustments to the video may be implemented. For example, the speaker's lip movements or other visual expressions may be slightly modified to better align with the adjusted audio, particularly when the new content includes rephrased or translated speech that alters the duration or rhythm of the original dialogue. Techniques such as pixel-level video editing adjustment models may be used to refine the visual elements without compromising the overall natural appearance of the video. The synthesized audio, combined with these visual adjustments, produces a final output video that appears natural and cohesive.

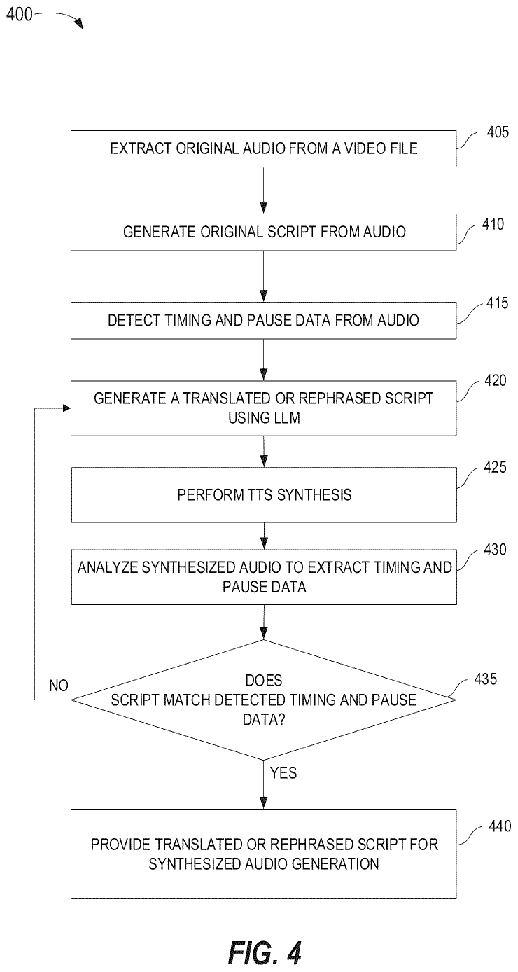

FIG. 4 depicts an example method 400 for generating a translated or rephrased script based on original audio timing and pauses, according to some embodiments of the present disclosure. The example method 400 may be performed by any computing device or system, such as physical computer or server, cloud-based system, or specialized hardware, as long as the device is configured with the necessary software and computational resources to execute the described example method (e.g., audio processing, transcription, and script generation).

At block 405, a computing system extracts the original audio (e.g., 325 of FIG. 3) from a video file. In some embodiments, the system may first identify and isolate the audio track from the video. The system may then decode the audio track into a raw format suitable for further processing, such as WAV or MP3.

At block 410, the computing system generates the original script (e.g., 105 of FIGS. 1 and 2) from the extracted audio. In some embodiments, transcription software or tools like WhisperX may be used to convert audio into text. In some embodiments, word-level timestamps may be identified, particularly for the start and end of each speech segment (e.g., 115-1 and 115-2 of FIG. 1), as well as pauses or natural breaks within each segment (e.g., 120-1 and 120-2 of FIG. 1). These timestamps provide precise timing information for when each word is spoken and when pauses occur. The identified timestamps may then be combined with the generated text to produce a script (e.g., 105 of FIGS. 1 and 2), which reflects both the linguistic content and timing structure of the original audio.

At block 415, the computing system analyzes the script to determine relevant timing and pause information. This involves examining the word-level timestamps to calculate the start and end times of each speech segment (e.g., a full sentence or phrase), as well as the duration and placement of pauses or natural breaks within each segment. In some embodiments, the system may compile the detected information into a detailed timing profile, which captures the structure of the original speech and serves as the foundation for further analysis and alignment.

At block 420, the computing system generates a translated (e.g., 110 of FIG. 1) or rephrased script (e.g., 210 of FIG. 2). An LLM may be used to create the script and/or align it with the timing and pauses identified in the original audio. In some embodiments, the created script may be a translation of the original audio into another language (e.g., Romanian). In such configurations, an initial translation is first generated, and then refinements are applied to ensure alignment with the timing profile. These refinements may include adding conjunctions, transitional phases, or filler woods to match the pauses and duration of speech segments without altering the meaning or intent of the script.

In some embodiments, the generated script may be a rephrased script (e.g., 210 of FIG. 2) with entirely new content, writing in the same language as the original. This configuration may be used for embodiments where the audio content needs to be replaced for creative purposes, such as updating narration, creating alternative versions of video content, or modifying education materials. In such configurations, the LLM may generate a draft of the new content based on the input requirements, replacing the original text with new material. The new script is then iteratively refined by adding conjunctions or fillers, or by rewording segments (e.g., including slightly expanding or compressing sentences) to match the timing requirements.

At block 425, a TTS synthesis is performed using the current version of the translated or rephrased script as input. Through the TTS conversion process, a temporary (or preliminary) synthesized audio sample is generated. In some embodiments, the preliminary synthesis may be executed quickly and efficiency, as the purpose is not to produce high-quality audio but to evaluate whether the script aligns correctly with the expected timing and pauses before final synthesis. Using the generated synthesized audio, at block 430, the system analyzes its structure to extract relevant timing and pause data. The extracted timing profile may include word-level timestamps, pause duration, and speech segment lengths. The detected timing and pause structure serves as a reference for evaluation in the next step.

At block 435, the computing system evaluates whether the translated or rephrased script aligns properly with the timing and pause data from the original audio. The evaluation process may include comparing the extracted timing data from the synthesized audio with the original audio's timing profile to identify differences or mismatches. The system may then determine whether the discrepancies fall within an acceptable threshold. Certain metrics may be used to measure these differences, such as timing delays or mismatch (e.g., differences in the start or end times of speech segments), pause duration variance (e.g., the deviation in the length of pauses or natural breaks), and speech-to-pause ratio (e.g., the proportion of spoken content to pauses). If the alignment is sufficient—the differences falls within a predefined threshold, such as a 20-millisecond delay tolerance or a 5% pause variance—the methods moves to block 440. If discrepancies are detected and exceed acceptable levels, the method returns to block 420, where the LLM readjusts the script (e.g., inserting conjunctions, filler words, or restructuring phrases) to improve synchronization. The updated script is processed through another iteration of TTS synthesis and timing extraction (blocks 425-435) until it meets the alignment criteria.

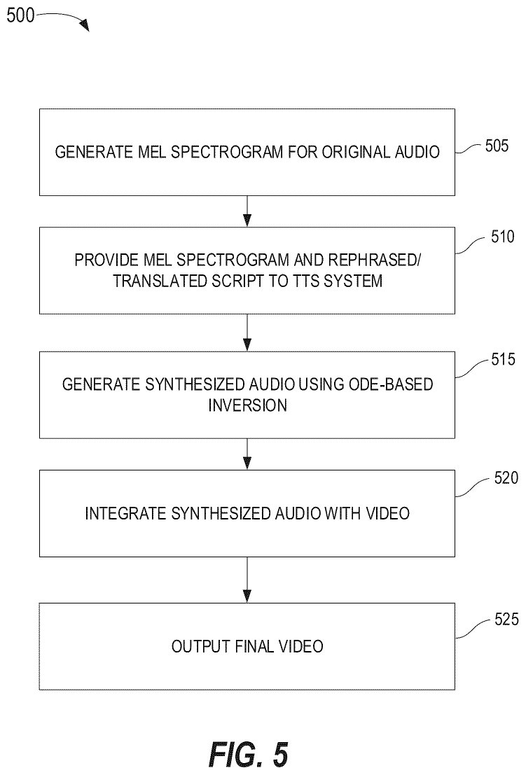

At block 440, the computing system provides the generated script (e.g., 305 of FIG. 3) to a TTS system (e.g., 310 of FIG. 3) for final synthesized audio generation. Unlike block 425, where a preliminary audio synthesis is performed for timing validation, this step initiates the synthesis process to generate the final synthesized audio that will be integrated into the video. The TTS system utilizes both the rephrased or translated script and the mel spectrogram of the original audio as inputs to generate the final, high-quality synthesized audio (e.g., 320 of FIG. 3). The mel spectrogram of the original audio serves as a reference, guiding the TTS system to learn the timing, frequency, and amplitude characteristics of the original speech. Using ODE-based inversion techniques, the system synthesizes new audio that matches the rhythm, pitch, and amplitude variations of the original and facilitates the natural integration of the new content from the rephrased or translated script. In some embodiments, the ODE-based inversion process may incrementally refine the waveform over a predefined number of steps (e.g., 32 timesteps by default). More details about this process, including mel spectrogram processing, iterative refinements, and final integration, are discussed below with reference to FIG. 5.

FIG. 5 depicts an example method 500 for generating synthesized audio using ODE-based mel spectrogram inversion and integrating synthesized audio with video content, according to some embodiments of the present disclosure. The example method 500 may be performed by any computing device or system, such as physical computer or server, cloud-based system, or specialized hardware, as long as the device is configured with the necessary software and computational resources to execute the described example method (e.g., audio processing, mel spectrogram generation, and ODE-based inversion with iterative refinement, and video-audio integration).

At block 505, a computing system processes the original audio (e.g., 325 of FIG. 3) to generates a mel spectrograms (e.g., 340 of FIG. 3) using time-frequency analysis techniques The generated mel spectrogram serves as a reference for shaping the new synthesized audio.

At block 510, the mel spectrogram of the original audio (e.g., 340 of FIG. 3) and the rephrased or translated script (e.g., 305 of FIG. 3) are provided as inputs to the TTS system (e.g., 320 of FIG. 3). At block 515, the TTS system generates synthesized audio by performing ODE-based inversion. This process involves refining the new audio waveform to align it with the timing, pauses, and frequency distribution of the original audio. More specifically, the mel spectrogram of the original audio serves as a reference during the ODE-based inversion process, guiding the generation of new audio that naturally integrates the new script while maintaining the structure of the original speech pattern. In some embodiments, the ODE-based inversion process may iteratively refine the waveform over a predefined number of steps (e.g., 32 timesteps by default). Each step incrementally adjusts the synthesized waveform to bring it closer to the reference mel spectrogram of the original audio. As used herein, the inversion strength parameter may control how many steps are executed. In some embodiments, the inversion strength may be adjusted for improved efficiency. For example, if the inversion strength is set to 0.1, the system may skip the first 10% of timesteps (e.g., steps 1-3) to avoid processing initial steps that contribute minimally to the final output, and complete the remaining 90% of the total steps (e.g., steps 4-28). Adjusting the inversion strength allows the system to improve computational efficiency, balancing speed and quality based on the requirements of the application. The iterative refinement process continues until the synthesized audio sufficiently aligns with the reference spectrogram's timing, pause structure, and frequency distribution.

At block 520, the system integrates the synthesized audio into the original video file by replacing the original audio track with the newly generated audio. At block 525, the computing system produces the final output video with the integrated synthesized audio (e.g., 365 of FIG. 3). The final video is then prepared for playback, storage, or distribution across various platforms and devices (e.g., mobile phones, laptops, desktop computers, tablets, television, projectors, or virtual and augmented reality headsets). In some embodiments, additional visual adjustments may be applied to further improve synchronization between the speaker's lip movements and the synthesized audio. For example, the speaker's lip movements may be modified using pixel-level editing or neural rendering techniques to better match the speech patterns of the synthesized audio. In embodiments where the synthesized audio conveys emotional tones that differ from the original, subtle adjustments to the speaker's facial expressions (e.g., lip curvature, jaw movement, or eyebrow position) may be implemented to improve alignment and realism. In some embodiments, the timing of individual video frames may be slightly adjusted or stretched to match the duration of the synthesized audio without disrupting the overall flow of the video.

Compared to conventional methods that focus on directly adjusting the lip movements to match the new audio, the disclosed approach saves computational resources and improves efficiency. Since the audio has already been adjusted to precisely align with the original audio's timing, pitch, and rhythm, the need for extensive visual editing is minimized (or at least reduced). Visual adjustments are limited to fine-tuning rather than broad modifications, making the process more efficient while producing high-quality video.

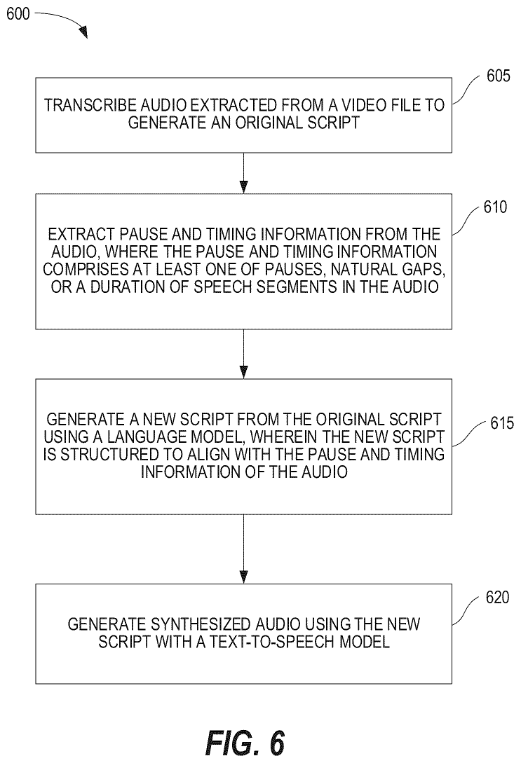

FIG. 6 is a flow diagram depicting an example method 600 for audio synchronization, according to some embodiments of the present disclosure.

At block 605, a computing system transcribes audio (e.g., 325 of FIG. 3) extracted from a video file to generate an original script (e.g., 105 of FIGS. 1 and 2).

At block 610, the computing system extracts pause and timing information (e.g., 115, 120, 125, and 130 of FIGS. 1 and 2) from the audio, where the pause and timing information comprises at least one of pauses, natural gaps, or a duration of a speech segment in the audio.

At block 615, the computing system generates a new script (e.g., 110 of FIG. 1 or 210 of FIG. 2) from the original script using a language model, where the new script is structured to align with the pause and timing information of the audio.

At block 620, the computing system generates synthesized audio (e.g., 320 of FIG. 3) using the new script with a text-to-speech model (e.g., 310 of FIG. 3).

In some embodiments, the computing system may further generate a mel spectrogram for the audio (e.g., 340 of FIG. 3), where the mel spectrogram represents at least one of timing, frequency, or amplitude characteristics of the audio, provide the mel spectrogram of the original audio (e.g., 340 of FIG. 3) as an input to the TTS model along with the new script (e.g., 305 of FIG. 3), and generate the synthesized audio (e.g., 360 of FIG. 3) by aligning the new script with the timing, frequency, and amplitude characteristics of the audio based on the mel spectrogram.

In some embodiments, the language model may comprise a large language model (LLM). In some embodiments, the new script may comprise a translated version of the original script in a target language.

In some embodiments, the process of generating the new script from the original script may comprise generating an initial translation (e.g., 110 of FIG. 1) of the original script in the target language, modifying the initial translation by inserting at least one of a conjunction, a transitional phrase, or a filter word into the initial translation to align with the gaps or natural breaks in the audio, and outputting the modified translation as the new script.

In some embodiments, the new script may comprise new content (e.g., 210 of FIG. 2) that is unrelated to the original script.

In some embodiments, the audio (e.g., 325 of FIG. 3) may be extracted from the video file by isolating an audio track from the video file, and decoding the audio track to extract audio data, and converting spoken content into text using a speech-to-text model.

In some embodiments, the computing system may integrate the synthesized audio into the video file, and output the video file with the synthesized audio to a user interface.

In some embodiments, the process of generating the new script from the original script may comprise generating an initial version of the new script with new content, modifying the new script by inserting at least one of a conjunction, a transitional phrase, or a filter word into the initial version to align with the gaps or natural breaks in the audio, or rephrasing the initial version to match the duration of the speech segment in the audio, and outputting the modified version as the new script.

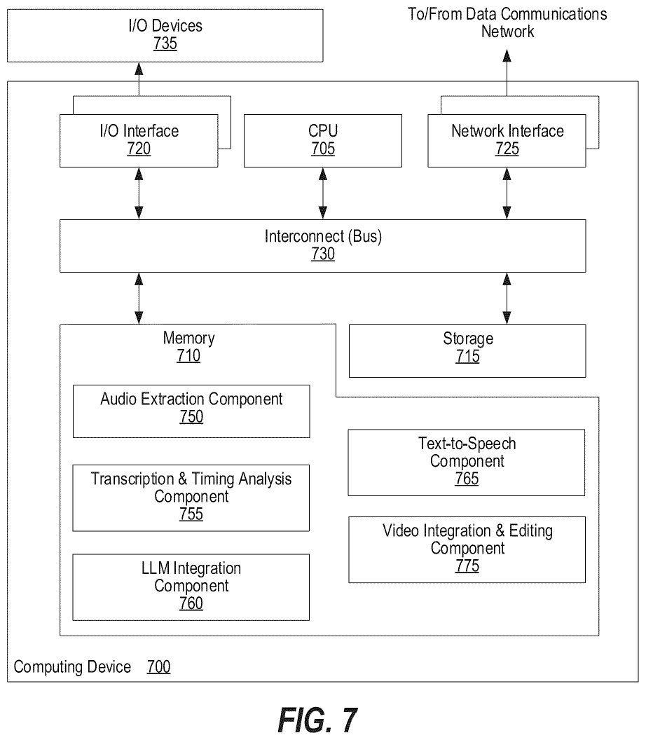

FIG. 7 depicts an example computing device 700 configured to perform various aspects of the present disclosure, according to some embodiments of the present disclosure.

As illustrated, the computing device 700 includes a CPU 705, memory 710, storage 715, one or more network interfaces 725, and one or more I/O interfaces 720. In the illustrated aspect, the CPU 705 retrieves and executes programming instructions stored in memory 710, as well as stores and retrieves application data residing in storage 715. The CPU 705 is generally representative of a single CPU and/or GPU, multiple CPUs and/or GPUs, a single CPU and/or GPU having multiple processing cores, and the like. The memory 710 is generally considered to be representative of a random access memory. Storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 735 (e.g., keyboards, monitors, camera 145 with built-in processor 150, as depicted in FIG. 1) are connected via the I/O interface(s) 720. Further, via the network interface 725, the computing device 700 can be communicatively coupled with one or more other devices and components (e.g., via a network, which may include the Internet, local network(s), and the like). As illustrated, the CPU 705, memory 710, storage 715, network interface(s) 725, and I/O interface(s) 720 are communicatively coupled by one or more buses 730.

In the illustrated aspect, the memory 710 includes an audio extraction component 750, a transcription and timing analysis component 755, an LLM integration component 760, a TTS component 765, and a video integration and editing component 770.

In one embodiment, the audio extraction component 750 is configured to isolate the audio track from video files, decode the audio track to extract audio data, and convert the audio data into a format suitable for further processing (e.g., WAV or MP3). In one embodiment, the transcription and timing analysis component 755 uses speech-to-text (STT) software or similar techniques to transcribe spoken content within the audio into text (e.g., 105 of FIGS. 1 and 2). This component further performs timing analysis to identify relevant timing data within the transcribed script, including the length (or duration) of speech segments, pauses, and natural breaks, among others.

In one embodiment, the LLM integration component 760 includes an interface or API for accessing an LLM (e.g., GPT-based systems or custom-trained models) for generating translated (e.g., 110 of FIG. 1) or rephrased scripts (e.g., 210 of FIG. 2). The LLM integration component 760 further includes refinement tools to iteratively align the rephrased or translated script's timing with the original audio. In some embodiments, the LLM integration component 760 may insert conjunctions, transitional phrases, or filler words into the script. In some embodiments, the LLM integration component 760 may rephrase the script to match the length (or duration) of speech segments in the audio.

In one embodiment, the TTS component 765 generates synthesized audio using an ODE-based inversion process. The TTS component 765 uses the mel spectrogram of the original audio as a reference to guide the synthesis of the new audio, generating a waveform that naturally integrates the new script while maintaining the structure of the original speech pattern. In some embodiments, the ODE-based inversion process may refine the waveform over a predefined number of steps (e.g., 32 timesteps by default), and inversion strength may be adjusted for improved efficiency.

In one embodiment, the video integration and editing component 770 replaces the original audio track in the video file with the synthesized audio. After integration, in some embodiments, the video integration and editing component 770 may perform further visual adjustments, including adjusting the speaker's lip movements to match with the synthesized audio, modifying facial expressions to better convey the tone of the new audio, or stretching or compressing frames to maintain synchronization with the new audio.

Although depicted as discrete components for conceptual clarity, in some aspects, the operations of the depicted components (and others not illustrated) may be combined or distributed across any number of components. Further, although depicted as software residing in memory 710, in some aspects, the operations of the depicted components (and others not illustrated) may be implemented using hardware, software, or a combination of hardware and software.

In the current disclosure, reference is made to various embodiments. However, it should be understood that the present disclosure is not limited to specific described embodiments. Instead, any combination of the following features and elements, whether related to different embodiments or not, is contemplated to implement and practice the teachings provided herein. Additionally, when elements of the embodiments are described in the form of “at least one of A and B,” it will be understood that embodiments including element A exclusively, including element B exclusively, and including element A and B are each contemplated. Furthermore, although some embodiments may achieve advantages over other possible solutions or over the prior art, whether or not a particular advantage is achieved by a given embodiment is not limiting of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, embodiments described herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments described herein may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations or block diagrams of methods, apparatuses (systems), and computer program products according to embodiments of the present disclosure. It will be understood that each block of the flowchart illustrations or block diagrams, and combinations of blocks in the flowchart illustrations or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations or block diagrams.

The flowchart illustrations and block diagrams in the Figures illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams or flowchart illustrations, and combinations of blocks in the block diagrams or flowchart illustrations, can be implemented by special purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A method, comprising:
transcribing audio extracted from a video file to generate an original script;
extracting pause and timing information from the audio, wherein the pause and timing information comprises at least one of pauses, natural gaps, or a duration of a speech segment in the audio;
generating a new script from the original script using a language model, wherein the new script is structured to align with the pause and timing information of the audio; and
generating synthesized audio using the new script with a text-to-speech (TTS) model.

2. The method of claim 1, wherein generating the synthesized audio using the new script with a text-to-speech model comprises:
generating a mel spectrogram for the audio, wherein the mel spectrogram represents at least one of timing, frequency, or amplitude characteristics of the audio;
providing the mel spectrogram of the original audio as an input to the TTS model along with the new script; and
generating the synthesized audio by aligning the new script with the timing, frequency, and amplitude characteristics of the audio based on the mel spectrogram.

3. The method of claim 1, wherein the language model comprises an large language model (LLM).

4. The method of claim 1, wherein the new script comprises a translated version of the original script in a target language.

5. The method of claim 4, wherein generating the new script from the original script comprises:
generating an initial translation of the original script in the target language;
modifying the initial translation by inserting at least one of: a conjunction, a transitional phrase, or a filter word into the initial translation to align with the gaps or natural breaks in the audio; and
outputting the modified translation as the new script.

6. The method of claim 1, wherein the new script comprises new content that is unrelated to the original script.

7. The method of claim 1, wherein the audio is extracted from the video file by isolating an audio track from the video file, and decoding the audio track to extract audio data, and converting spoken content into text using a speech-to-text model.

8. The method of claim 5, further comprising:
integrating the synthesized audio into the video file; and
outputting the video file with the synthesized audio to a user interface.

9. The method of claim 6, wherein generating the new script from the original script comprises:
generating an initial version of the new script with new content;
modifying the initial version by:
inserting at least one of: a conjunction, a transitional phrase, or a filter word into the initial version to align with the gaps or natural breaks in the audio, or
rephrasing the initial version to match the duration of the speech segment in the audio; and
outputting the modified version as the new script.

10. A non-transitory computer-readable medium containing computer program code that, when executed by operation of one or more computer processors, performs an operation comprising:
transcribing audio extracted from a video file to generate an original script;
extracting pause and timing information from the audio, wherein the pause and timing information comprises at least one of pauses, natural gaps, or a duration of a speech segment in the audio;
generating a new script from the original script using a language model, wherein the new script is structured to align with the pause and timing information of the audio; and
generating synthesized audio using the new script with a text-to-speech (TTS) model.

11. The non-transitory computer-readable medium of claim 10, wherein generating the synthesized audio using the new script with a text-to-speech model comprises:
generating a mel spectrogram for the audio, wherein the mel spectrogram represents at least one of timing, frequency, or amplitude characteristics of the audio;
providing the mel spectrogram of the original audio as an input to the TTS model along with the new script; and
generating the synthesized audio by aligning the new script with the timing, frequency, and amplitude characteristics of the audio based on the mel spectrogram.

12. The non-transitory computer-readable medium of claim 10, wherein the language model comprises an large language model (LLM).

13. The non-transitory computer-readable medium of claim 10, wherein the new script comprises a translated version of the original script in a target language.

14. The non-transitory computer-readable medium of claim 13, wherein generating the new script from the original script comprises:
generating an initial translation of the original script in the target language;
modifying the initial translation by inserting at least one of: a conjunction, a transitional phrase, or a filter word into the initial translation to align with the gaps or natural breaks in the audio; and
outputting the modified translation as the new script.

15. The non-transitory computer-readable medium of claim 10, wherein the new script comprises new content that is unrelated to the original script.

16. The non-transitory computer-readable medium of claim 10, wherein the audio is extracted from the video file by isolating an audio track from the video file, and decoding the audio track to extract audio data, and converting spoken content into text using a speech-to-text model.

17. The non-transitory computer-readable medium of claim 10, further comprising:
integrating the synthesized audio into the video file; and
outputting the video file with the synthesized audio to a user interface.

18. A system, comprising:
one or more memories collectively containing one or more programs; and
one or more processors, wherein the one or more processors are configured to, individually or collectively, perform an operation comprising:
transcribing audio extracted from a video file to generate an original script;
extracting pause and timing information from the audio, wherein the pause and timing information comprises at least one of pauses, natural gaps, or a duration of a speech segment in the audio;
generating a new script from the original script using a language model, wherein the new script is structured to align with the pause and timing information of the audio; and
generating synthesized audio using the new script with a text-to-speech (TTS) model.

19. The system of claim 18, wherein generating the synthesized audio using the new script with a text-to-speech model comprises:
generating a mel spectrogram for the audio, wherein the mel spectrogram represents at least one of timing, frequency, or amplitude characteristics of the audio;
providing the mel spectrogram of the original audio as an input to the TTS model along with the new script; and
generating the synthesized audio by aligning the new script with the timing, frequency, and amplitude characteristics of the audio based on the mel spectrogram.

20. The system of claim 18, wherein the new script comprises a translated version of the original script in a target language, and generating the new script from the original script comprises:
generating an initial translation of the original script in the target language;
modifying the initial translation by inserting at least one of: a conjunction, a transitional phrase, or a filter word into the initial translation to align with the gaps or natural breaks in the audio; and
outputting the modified translation as the new script.
